(19) United States
(12) Patent Application Publication
(10) Pub. No.: US 2023/0192154 A1
(43) Pub. Date: Jun. 22, 2023

(54) Surface Conditioning Of Railway Tracks Or Wheels

(71) Applicant: PLASMATRACK LIMITED, Greater London (GB)

(72) Inventors: Julian Swan, Ealing (GB); Matthew Candy, Greater London (GB)

(21) Appl. No.: 17/915,208

(22) PCT Filed: Apr. 6, 2021
(86) PCT No.: PCT/GB2021/050845

§ 371 Date: Sep. 28, 2022

(30) Foreign Application Priority Data
Apr. 2, 2020 (GB) 2004896.3

(51) Int. Cl. B61C 15/08; E01H 8/08; E01H 8/10; B61K 9/08; B08B 7/00; B08B 13/00; C23G 5/00; H05H 1/48

(52) U.S. Cl. CPC B61C 15/085; B08B 7/0035; B08B 13/00; B61K 9/08; C23G 5/00; E01H 8/08; E01H 8/10; H05H 1/48; H05H 2242/10; H05H 2245/40

(57) ABSTRACT

A surface conditioning device for railway track rails and/or railway vehicle wheels includes a DC power supply, a supply of gas, a plasma delivery head connected to receive DC power from the power supply and gas from the gas supply, and an igniter for igniting the gas in the plasma delivery head. In use, plasma is generated within the delivery head by ignition of the gas in the delivery head. Plasma with gas is blown from the delivery head onto a railway track rail and/or railway vehicle wheel, thereby conditioning the rail and/or wheel.

### CROSS REFERENCE TO RELATED APPLICATIONS

This is the U.S. National Stage application of International Application No. PCT/GB2021/050845, filed Apr. 6, 2021, which claims the benefit of priority from GB Application No. 2004896.3, filed Apr. 2, 2020. The entire contents of these prior applications are incorporated by reference herein.

### FIELD

This invention pertains generally to the field of surface conditioning, and in particular, surface conditioning devices and methods for use on railway track rails and railway vehicle wheels to help maintain the optimum condition of rail to wheel interface.

### BACKGROUND

The surface condition of railway tracks presents a real challenge to rail network operators who must ensure that they are well maintained and kept in optimum condition for the passage of rail vehicles. The railway track rails, typically made from steel, are subjected to considerable forces from passing vehicles that can cause surface and structural wear, whilst also being exposed to adverse and frequently changeable weather conditions, along with other environmental hazards throughout the year. The rail to wheel interface, typically steel against steel, provides an energy efficient combination, yet this interface can prove to be highly sensitive to contamination. Precipitation, dew, leaf fall, localised temperature changes, extreme weather conditions, vegetation and other detritus, are just some of the events that can affect the surface condition of the rail track, and therefore the passage of the rail vehicle passing thereon. The majority of these contaminants have significant water content, which affects adhesion of the wheel on the rail surface.

The smooth, safe and efficient running of a rail vehicle relies upon the friction between the steel rails and the steel wheels. Fundamental to predictable and optimised braking of a rail vehicle using conventional brakes, is creating a reliable rail to wheel interface that has sufficient friction for the desired rate of deceleration. Friction can be reduced when the rails become slippery or greasy, often because of rain, dew, fluids such as oil or even decomposing leaves that fall onto the line and can become compacted. This can result in a chemical reaction occurring between the water-soluble leaf component and steel rail coating. This coating is semi-permanent and therefore it may take time to be sufficiently worn away by the passage of trains. Such variance and unpredictability to surface conditions of the rail tracks in terms of moisture and detritus can present a real challenge to network operators. They must predict the likelihood of low friction conditions being experienced by a passing vehicle, causing the vehicle to slip, before this happens, and take steps to minimise the impact. They must carry out ongoing monitoring of track conditions to flag up areas of concern and again take steps to rectify these. They must ensure that trains are adequately spaced along the line to ensure that required stopping distances are taken into account in light of changeable surface conditions. With such conditions subject to change at any moment, particularly environmental conditions due to changeable weather, it is very common for issues to occur. Rail network operators are quick to delay or cancel trains, rather than risk passenger safety. Timetables are often altered for different seasons, such as in the UK regular Autumnal timetabling takes place to anticipate these delays during the leaf fall season. This comes at considerable cost to the rail industry. It was estimated that leaves on the line costs around £60million in direct costs each year in the UK alone, which is estimated to amount to around £350million societal costs.

A loss of friction at the rail to wheel interface effects traction when the train first sets off and starts moving, which in the case of freight trains, affects hauling capability. The wheels can be caused to spin, and in some instances the train is unable to move. These low friction conditions result in poor adhesion between the wheel to rail interface, also causing issues when braking and coming to a stop. Substantial loss of friction results in reduced braking forces, meaning that stopping distances are considerably longer and this must be accounted for when dispatching trains within the rail network. In extreme cases the wheels may even lock, causing the train to go into a slide. This can cause considerable damage to the wheel and rail track. Station platforms may also be overshot where a driver has not allowed a sufficient distance to bring the train to a standstill.

Snow and ice, when deposited on rail tracks, can cause such low adhesion conditions to occur, making rail vehicles prone to slide or slip during braking, whilst also causing the train to encounter difficulties pulling away. But less obvious conditions such as light rain following a spell of dry weather, or morning dew on the rails, can also cause challenging rail conditions for the rail networks to account for. The effect on the surface condition of the rail tracks may only be short term, but the unpredictable nature of such effects may be sufficient for a significant incident to occur to a passing rail vehicle. Tests have shown that there is a strong correlation between low adhesion incidents and the occurrence of the dew point, where water vapour from the air condenses onto the railhead forming a fluid film. This fluid film leads to a loss of traction at the wheel to rail interface.

Other contributing factors are thought to include the move from brake shoes to disc brakes, which means that some surface cleaning and conditioning of the rails no longer occurs by abrasion. It is also thought that rail network operators no longer have to carry out sufficient lineside maintenance that would have been essential during the steam locomotive era, to prevent vegetation from catching fire. The extra growth from vegetation increases the supply of leaves and the increase of leaf fall onto the line, thereby exacerbating the problem. It may also affect the dew point and localised climate in some areas. In extreme cases, the build-up of leaf matter can electrically insulate the wheels from the rails, resulting in signal failure. This can cause an event such as Wrong Side Track Circuit Failure, or WSTCF, when leaf matter electrically insulates the wheels from the rails resulting in signal failure. Other events such as Signal Passed at Danger, or SPAD, can also occur when a train slides past a signal because it could not stop.

Rail vehicles are typically fitted with wheel slide protection, in an attempt to counter slippery rail conditions. When wheels become locked, flat spots can be ground into the steel rims, especially if the wheel is still sliding when entering a non-slippery portion of rail track. This can cause wheel flats, where the wheel shape has been altered from its original profile, leading to severe vibrations and the need for reprofiling of the wheels, or even wheel replacement, at considerable expense.

Numerous different ways of surface conditioning the rail tracks to deal with such changeable circumstances have been tried, and many are in operation. These range from applying a jet to blast away any deposits or detritus, such as with water jets alongside a mechanical scrubbing apparatus of some form. Laser blasting the rails has also been tried and tested. Or coating the rail tracks and/or wheels with a high friction material, such as by depositing sand as a paste or otherwise, or the application of adhesion modifying chemicals, onto the rail. The sand assists adhesion during braking and acceleration. However, using sand may increase the risk of unwanted insulation, and therefore the sand may also contain metal particles. For an example, an adhesion modifier such as Sandite™, a combination of sand, aluminium particles and adhesive. Blasting or coating the rails with sand and substances such as Sandite™ is not thought to offer an economically sound solution, nor is it thought to be environmentally friendly to release these substances into the environment. Alternative coatings currently in use include Track Grip 60™ (TG60™) an adhesion enhancer for rails, or Electragel, which consists of steel particles and sand, suspended in a gel. To attempt to combat the issues experienced by moisture and the formation of dew on the rail tracks, and thereby improve both traction and impedance properties, the rails have typically been treated with hydrophobic products. To apply these coating or treatments to the rail tracks typically requires special trains or rail vehicles, and may also involve manual or application by hand. In the UK these vehicles typically include Rail Head Treatment Trains or RHTTs, or Multi-Purpose Vehicles or MPVs. Again, a challenge for the rail network operators to factor into the overall operation of the network, ensuring the passage of such rail vehicles, or the application of such coating and substances at times when the track is not in use.

At specific sites, or portion of rail track, where significant low adhesion regularly occurs, such as on the approach to a station, traction gel applicators may have been installed. These apply liquid to the railhead as a rail vehicle passes therethrough.

These processes are only effective for a short period of time. Jet blasting the rail track is ineffective as soon as the next leaf falls, or is positioned onto the rails due to the aerodynamic turbulence of a passing train, or other detritus lands along the line. Sand and other treatment products deposited directly onto the rail track or railhead may prove more durable, but these substances can be easily washed away by rainfall.

The prior art shows a number of devices which attempt to address these needs in various ways.

U.S. Pat. No. 3,685,454(British Railways Board) discloses a means of cleaning rails to improve wheel to rail adhesion, using a plasma torch or plurality of plasma torches supported on a vehicle. The apparatus comprises an electromagnetic detector mounted on the carrier for detecting and transmitting an error signal when a torch head is no longer acting upon the rail track at a suitable distance from said track. This document introduces the use of plasma torches to condition the track surface, but is more concerned with positioning of the torch head in relation to the track, than a combination of efficient and effective plasma generation alongside application to the rail track to railhead interface.

GB 1 179 391 (Tetronics R&D Company Ltd) discloses an apparatus and method of cleaning a metal surface by treating the surface with a gaseous effluent from a source of superatmospheric high current density arc plasma. In one embodiment the apparatus is configured to be incorporated within a railway locomotive or tram. This document discloses the use of a constricted arc plasma jet for increasing the friction between the wheel treads of railway vehicles and the rail head surfaces. The device is mounted to the rail vehicle and treats the rail head just before the wheel tread makes contact with it.

Whilst the prior art appears to address the issue of removing some of the detritus, moisture or other matter from a rail track and/or wheel, thus improving the adhesion between the two surfaces, it does not propose a solution that conditions the surface of the rail track and or surface of the wheel on a continuous or intermittent basis, during travel of a passing rail vehicle, thereby requiring minimal intervention by a rail network provider. Whilst the prior art also attempts to address the issue of improving friction and therefore adhesion of the rail track surface, by cleaning the surface through sand blasting, jet blasting or the addition of chemical substances, it does not provide a means of conditioning said track surface, and sensing and responding to a change of conditions of the track surface on an instantaneous basis. The wheel to rail interface, and the adhesion of one surface to the other, is not optimised by these proposed solutions to the point where normal levels of braking of the rail vehicle can be applied throughout the network and during ever-changing conditions.

Whilst the prior art appears to introduce the application of plasma for cleaning rails, and recognises that the treatment of rails with a plasma torch is effective, it also presents a number of problems with simply mounting a plasma torch to a rail vehicle, such as an excessive power requirement to generate the required plasma, the need with such proposals to mount the torch extremely close to the rail to be conditioned and the challenges that this presents, and the additional safety and maintenance problems of using plasma that have not been addressed. Selection of the plasma forming gas is also key. Individual gases like air, nitrogen, argon, helium, hydrogen and steam are often used as plasma forming gases. A mixture of these gases, such as argon and hydrogen, nitrogen and hydrogen, nitrogen and oxygen can also be used to form plasma. It is thought that plasma forming gas must have high thermal conductivity to supply sufficient heat to a rail, high ionisation energy, and high atomic weight to provide sufficient energy to remove material from the rail. The prior art does not address these problems.

### BRIEF SUMMARY

Preferred embodiments of the present invention aim to provide a surface conditioning device for conditioning the surface of rail track rails and/or rail vehicle wheels, on a continuous or intermittent basis, during the passage of a rail vehicle along the track, the surface conditioning device providing means to target water and other contaminants by delivering energy to the rail to wheel interface, to effectively remove moisture, debris and other detritus from said interface, thus improving friction and therefore adhesion therebetween. Preferred embodiments also aim to provide a conditioned rail track and wheel interface, in an energy efficient manner, with no detriment to the track and/or rail and without an excessive power requirement. Further embodiments of the present invention aim to provide a surface conditioning device for a rail to wheel interface, that supplies and optimises treatment conditions of the rail track surface in direct response to a change in conditions. By optimising adhesion at the rail to wheel interface, allows for consistent braking of a rail vehicle, reducing the likelihood of wheel and/or rail damage such as wheel flats.

According to one aspect of the present invention, there is provided a surface conditioning device for railway track rails and/or railway vehicle wheels, the device comprising: a DC power supply; a supply of gas; a plasma delivery head connected to receive DC power from said power supply and gas from said gas supply; and an igniter for igniting said gas in said plasma delivery head: wherein, in use, plasma is generated within said delivery head by ignition of said gas in said delivery head, and plasma with gas is blown from the delivery head onto a railway track rail and/or railway vehicle wheel, thereby to condition said rail and/or wheel.

In the context of this specification, ‘blown’ is used in a general sense to refer to the delivery of plasma to a target surface - in this case, a railway track rail and/or railway vehicle wheel.

Preferably, the gas may comprise nitrogen.

The gas may comprise a mixture of gases.

The mixture of gases may comprise a mixture of hydrogen and nitrogen or a mixture of nitrogen and oxygen.

Preferably, the gas may include argon as an initial gas to initiate ignition and another gas or mixture of gases to replace the argon and generate the plasma.

Preferably, the power supply may comprise a dual-voltage inverter power supply.

The surface conditioning device may comprise a heat exchange system that is operative to reduce the temperature at or in the vicinity of the plasma delivery head.

The surface conditioning device may comprise an anti-freeze system that is operative to circulate an anti-freeze medium at or in the vicinity of the plasma delivery head.

The surface conditioning device may comprise a cooling system that is operative to circulate coolant at or in the vicinity of the plasma delivery head.

Preferably, the plasma delivery head may operate at a temperature in the range 300° C. to 1,500° C.

The surface conditioning device may comprise a Raman spectrometer that is operative to sense the presence or absence of contaminants on a railway track rail and/or railway vehicle wheel, without contact with the rail or wheel.

The Raman spectrometer may be operative to analyse the composition of said contaminants and indicate a level of contamination.

The surface conditioning device may comprise an optimiser that is operative to optimise energy requirement for conditioning of the rail or wheel, in response to an output of the Raman spectrometer.

The Raman spectrometer may be operative to sense a level of achievement of conditioning of a rail or wheel.

The surface conditioning device may comprise a plurality of said plasma delivery heads spaced along a direction of travel along a rail, such that said delivery heads successively condition the rail, one after another.

The surface conditioning device may comprise an operating interface whereby a user can control operation of the device.

According to a further aspect of the present invention there is provided a method of conditioning a railway track rail and/or railway vehicle wheel, the method comprising operating a surface conditioning device as hereinbefore described to condition a rail or wheel.

The surface conditioning device may be operated on a railway vehicle as it travels along a railway track rail.

The surface conditioning device may be operated as the railway vehicle makes multiple passes along the railway track rail.

### BRIEF DESCRIPTION OF THE DRAWINGS

For a better understanding of the invention, and to show how embodiments of the same may be carried into effect, reference will now be made, by way of example, to the accompanying diagrammatic drawings, in which:

FIG. 1 shows one embodiment of surface conditioning device as a schematic diagram, showing the inter-relationship between a nitrogen generator, DC power supply and a chilling system to deliver coolant, a nitrogen supply and a high voltage supply through outputs A, B and C;

FIG. 2 shows one embodiment of plasma delivery head in section view, showing the inputs A, B and C from FIG. 1, delivering the coolant, nitrogen supply and high voltage supply to the plasma delivery head;

FIG. 3 shows one embodiment of a surface conditioning device when mounted to a railway vehicle, showing a pair of plasma delivery heads between wheels of said railway vehicle;

FIG. 4 shows a further embodiment of surface conditioning device when mounted to a manual track treatment vehicle, showing a remote location of nitrogen generator, ignition box and DC Power supply operatively connected to a plasma delivery head;

FIG. 5 shows a further embodiment of surface conditioning device when configured as a railway vehicle specific for rail track treatment, showing possible locations for mounting plasma delivery heads;

FIG. 6 shows a further embodiment of surface conditioning device when mounted to a locomotive, showing possible locations for mounting plasma delivery heads to railway vehicles for carrying passengers or freight;

FIG. 7 shows a pair of plasma delivery heads of FIG. 2 in isometric view, and the relationship of the plasma delivery heads to wheels of a railway vehicle when configured to surface condition rails;

FIG. 8 shows a side view of one of the plasma delivery heads of FIG. 7, and the relationship of the plasma delivery head to the wheel when configured to surface condition the rail;

FIG. 9 shows a side view of a plasma delivery head of FIG. 2, and the relationship of the plasma delivery head to the wheel of a railway vehicle when configured to treat the wheel;

FIG. 10 shows a pair of plasma delivery heads of FIG. 2 in isometric view, when configured to treat respective wheels; and

FIGS. 11 to 15 show a series of graphs that show the impact that a surface conditioning device has on the surface condition of a rail, showing change in condition with successive passes.

In the figures, like references denote like or corresponding parts.

### DETAILED DESCRIPTION

It is to be understood that the various features that are described in the following and/or illustrated in the drawings are preferred but not essential. Combinations of features described and/or illustrated are not considered to be the only possible combinations. Unless stated to the contrary, individual features may be omitted, varied or combined in different combinations, where practical.

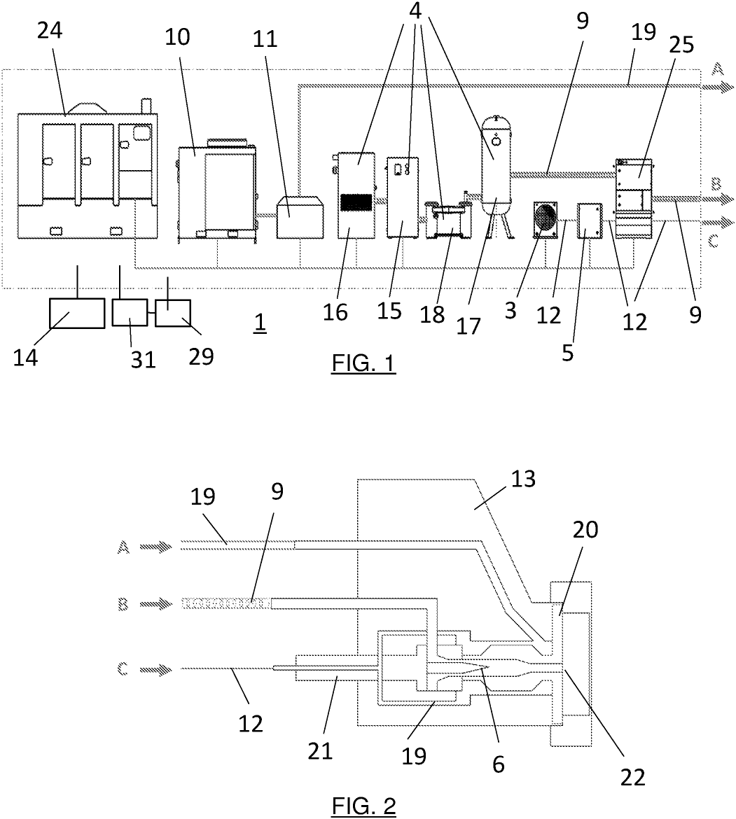

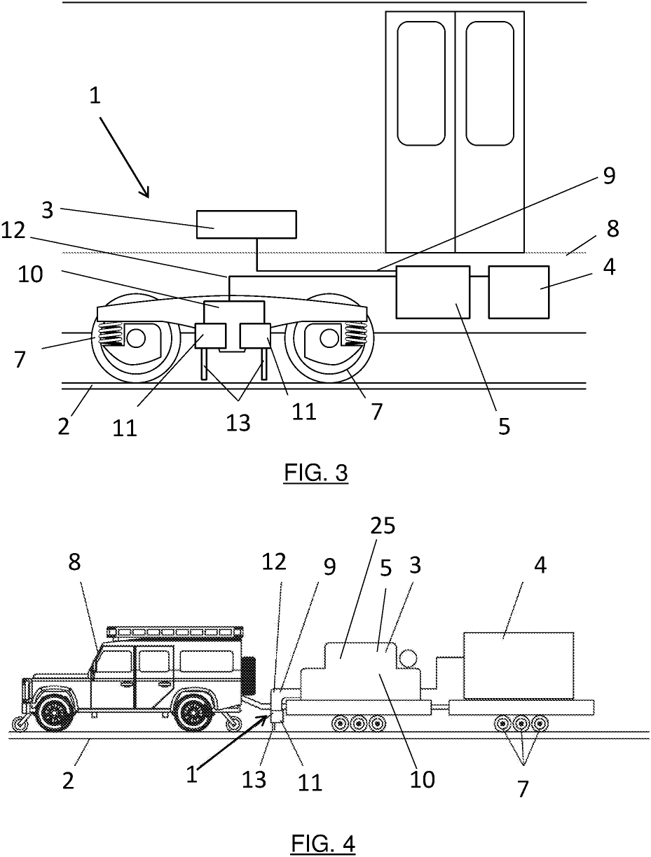

FIG. 1 shows one embodiment of surface conditioning device 1 showing an AC three-phase generator 24 operatively connected to a number of components that make up the surface conditioning device 1, to provide a source of power to these components. The generator 24 input may be from a rechargeable battery, or it may use regenerative power. The components that may be provided with power from the generator 24 include a chilling system 10, heat exchanger 11, nitrogen generator 4, DC power supply 3, an ignition box 5 and a gas box 25. The surface conditioning device 1 may be manually controlled by an operator through an operating interface 14. One or more sensors, not shown, may be in communication with operating interface 14 to operate the surface conditioning device 1 in response to one or more conditions. For an example, the surface conditioning device 1 may be configured to condition the surface of a rail 2 and/or wheel 7 when a railway vehicle 8 (e.g. in FIG. 3) begins braking. In a further example, the surface conditioning device 1 may respond to environmental conditions, such as the detection of moisture in the vicinity of the rail 2, or in response to a drop in temperature of the environment surrounding the rail 2. This allows surface conditioning to occur in direct response to a specific condition being detected, by the railway vehicle 8 that has detected the condition. It also allows railway vehicles 8 that pass along the rails 2 to condition these rails 2 as they travel. The surface conditioning device 1 may be configured to sense and analyse the nature and intensity of the contaminant. For an example, if the quantity of contaminant is less than say expected, the plasma energy supplied may be dialled down accordingly, or vice versa for heavy contamination.

The DC power supply 3 is configured to generate a direct current from an AC supply received from the generator 24, and to provide a high voltage supply 12 of DC current to the ignition box 5. The ignition box 5 provides the circuitry to generate a spark at an igniter 6 within the plasma delivery head 13, shown in FIG. 2. Plasma is generated within the plasma delivery head 13, by striking an electric arc between an anode 20 and a cathode 21, whereby a spark is created at a tip of the igniter 6. A plasma jet then emerges from plasma delivery head 13, and onto the rail 2 or wheel 7.

The surface conditioning device 1 incorporates the nitrogen generator 4. This nitrogen generator 4 comprises an air compressor 16, that feeds compressed air into a membrane nitrogen generator 15. This membrane nitrogen generator 15 separates the compressed air, and passes a supply of nitrogen from this compressed air into a condensate treatment 18. The condensate treatment 18 is configured to condense the nitrogen and supply a feed of this into a pressure vessel 17. The pressure vessel 17 pressurises the nitrogen to generate a nitrogen supply 9 that is suitable for passing by tube to the gas box 25.

The gas box 25 may house one or more of the following components: primary and secondary gas mass flow controllers, control PLC with industry standard Ethernet interface, control valves and switching for sequencing and safe operation of the system, E-stop circuit. Signals from these components can all be linked into a control system through the operating interface 14. The gas box 25 may also comprise interlocks to inhibit system operation unless the following are within preset limits: coolant pressure, temperature and flow; primary, secondary and/or carrier gas pressure and flow, a fault indication strobe, control connections for DC power supply 3, or DIPS power supply.

FIG. 2 shows the plasma delivery head 13, that may be referred to as a plasma gun or pistol. The igniter 6, within the plasma delivery head 13, is configured to ignite the nitrogen supply 9 by generating a spark within the plasma delivery head 13. A single spark from the igniter 6 excites and ignites the nitrogen supply 9, and by adding such heat energy the nitrogen supply 9 loses some of its electrons, becoming ionised and converted into plasma. The generated plasma is carried by the nitrogen supply 9, and gains energy from the high voltage supply 12 supplied by the DC power supply 3. More plasma is generated from the nitrogen supply 9 by the generated plasma and the high voltage supply 12 exciting and ionising the gas at atmospheric pressure. A gas vortex is generated by the nitrogen supply 9 and this vortex continues to become excited by the high voltage supply 12 driving the plasma through a nozzle 22 and out of the plasma delivery head 13 to be blown onto the surface to be conditioned. The nozzle 22 helps to contain and concentrate the plasma. This configuration enables a high velocity blast of plasma to be delivered to the rail or wheel to be conditioned. This facilitates thermal ablation of contaminant on the rail or wheel.

It is to be noted that devices embodying the invention preferably employ a non-transferred configuration, without any additional current between the plasma delivery head 13 and rail surface or wheel to be conditioned.

In an alternative embodiment a first gas is introduced into the plasma delivery head 13, prior to the nitrogen supply 9. This first gas is readily ignited. One example of suitable first gas is argon. Once the argon has been ignited at the igniter 6 by a spark, and plasma begins to form, the current and voltage can be increased and then the nitrogen supply 9 is introduced into the plasma delivery head 13, to achieve stable plasma. The first gas, not shown, is configured to pass along the same supply line as the nitrogen supply 9. The moment at which the supply of gas switches from argon to nitrogen is automatically determined by control circuitry, and is timed to ensure optimum levels of plasma are generated.

The igniter 6 may only be activated for a few seconds, sufficient to generate a spark and ignite the nitrogen supply 9, or other gas supply suitable for igniting. The nitrogen supply 9 may alternatively comprise another gas that can be any monoatomic or diatomic, or a gas mixture. For an example, the gas mixture may comprise water molecules added to the gas.

The surface conditioning device 1 may incorporate a chilling system 10, to ensure that the plasma delivery head 13 is not allowed to exceed a predetermined temperature level that could cause risk to the surroundings, and could also cause damage to the plasma head as components of the head could melt. This chilling system 10 is configured to help cope with the high heat loads that the plasma delivery head 13 experiences. The chilling system 10 may comprise a coolant reservoir or coolant generator, to supply coolant 19 to the plasma delivery head 13. The coolant 19 may comprise water, oil or similar fluid for drawing heat energy from the plasma delivery head 13.

The chilling system 10 is shown operatively connected to the heat exchanger 11. The heat exchanger generates the supply of coolant 19 that is then fed to the plasma delivery head 13.

FIG. 2 shows one embodiment of plasma delivery head 13 that is operatively connected to FIG. 1 through the three inputs A, B and C. These inputs comprise nitrogen supply 9 from the nitrogen generator 4, high voltage supply 12 from the DC power supply 3, and coolant 19 from the chilling system 10 to the plasma delivery head 13. The plasma delivery head may incorporate a delivery tube that comprises a hollow, elongate tube of electrically conductive material, for example copper, configured to supply plasma to a surface. The plasma delivery head 13 may incorporate a nozzle 22 for delivering plasma to a surface. The nozzle 22 may be a separate element affixed to a plasma output of the plasma delivery head 13. Alternatively, the nozzle 22 may be formed as part of the plasma delivery head 13, and may be shaped at one end to form an effective nozzle 22, through its geometry, such as venturi, divergent, convergent or asymmetrical. The nozzle 22 helps to focus the plasma onto the portion of rail 2 or wheel 7 that is to be treated. This portion of surface of rail 2 or wheel 7 is likely to be within the range of 5 mm to 20 mm that is to be conditioned at any one time. Mounting the end bore of the nozzle 22 at a distance of between 25 mm and 75 mm to the surface to be conditioned provides sufficient coverage to this portion of rail 2. The nozzle 22 may comprise metal, which would therefore reduce EMC emissions. The nozzle 22 and/or plasma delivery head 13 may incorporate some form of shielding, not shown, for shielding the surroundings. The shielding may shield against UV light and may also create an aerodynamic effect to assist delivery of the plasma onto the railway track rail 2.

The distance between the plasma delivery head 13 and the rail or wheel to be conditioned may be in the range 10 mm to 75 mm. A distance in the range 10 mm to 25 mm may facilitate improved conditioning.

The surface conditioning device 1 may incorporate at least one mounting means, not shown, for mounting the component parts that make up the surface conditioning device 1 to a railway vehicle 8. This mounting means may be permanent or releasable. Permanent means might include welding, or securing through a plurality of bolts or rivets to the railway vehicle 8.

The surface conditioning device 1 may incorporate at least one sensor, not shown, for sensing a condition and activating the surface conditioning device 1 in response to a change or a predetermined value for that condition. The sensor may comprise a Raman spectrometer. The sensor may comprise a thermal sensor, mechanical sensor and/or motion sensor, or any combination of these. Thermal sensors detect a change in temperature within a surrounding environment, which may affect the condition of rails 2 and require surface conditioning to be activated to ensure that the surface of the rails 2 remains unaffected by the change. Thermal sensors may comprise thermometers or thermostats. The sensor may comprise a motion sensor or speed sensor, such as an accelerometer or speedometer, for detecting retardation or braking of a railway vehicle 8, and activating the surface conditioning device 1 during braking of the railway vehicle 8. The sensor may comprise a frictional sensor, visual track condition sensor or slippage sensor. This should help to prevent slip between the rail 2 and wheel 7 interface. The sensor may also comprise a moisture sensor for detecting dew within the immediate environment surrounding a rail 2.

FIG. 3 shows one embodiment of surface conditioning device 1 when mounted between the wheels 7 of a typical railway vehicle 8. The wheels 7 run along a rail 2 or rail head, and the surface conditioning device 1 is mounted such that it conditions the surface of the rail 2 as the railway vehicle 8 passes along. The surface conditioning device 1 comprises at least one DC power supply 3, at least one nitrogen generator 4 and at least one plasma delivery head 13. The DC power supply 3 may be a Dual-voltage Inverter Power Supply (DIPS). Shown in FIG. 3 is a pair of plasma delivery heads 13 mounted adjacent to one another. The surface conditioning device 1 may comprise a modular arrangement with multiple plasma delivery heads 13. In such a modular arrangement the plasma delivery heads 13 may be mounted at various locations throughout the railway vehicle 8 to enable the surface conditioning device 1 to condition a surface of the rails 2 and/or to condition a surface of the wheels 7 of the railway vehicle 8 at any one time, intermittently or on an ongoing basis. Each plasma delivery head 13 may be controlled independently or all of the plasma delivery heads 13 may be controlled to operate at the same time, through the operating interface 14, not shown, where the operating interface 14 is within a driver’s cab of the railway vehicle 8. The operating interface 14 may be mounted at a suitable location within the railway vehicle 8 such that a display of can be read and responded to by a rail vehicle operator.

Each plasma delivery head 13 is operatively connected to the nitrogen supply 9, the high voltage supply 12, and the supply of coolant 19 for generating plasma and delivering this plasma onto the rail 2 and/or wheel 7. The plasma delivery head 13 is mounted to the railway vehicle 8 such that the end is at a suitable distance from the surface of the rail 2 for conditioning this surface. Mounting the plasma delivery heads 13 between wheels 7 of the railway vehicle 8 ensures that the plasma delivery heads 13 are shielded from the harsher conditions experienced in front of the leading wheel 7 of the railway vehicle 8. The railway vehicle 8 may be a locomotive or carriage of any railway vehicle 8 for transporting passengers or freight, and the surface conditioning means 1 may therefore be carried out during the usual passage of the railway vehicle 8 along the rails 2.

FIG. 4 shows the surface conditioning device 1 forming part of a specialist railway vehicle 8 or manual track treatment vehicle. This railway vehicle 8 has the sole purpose of travelling along rails 2, providing means to condition these rails 2. This track treatment vehicle is provided with carriages that carry the components of the surface conditioning device 1. In the configuration shown, the second carriage carries the nitrogen generator 4, and this carriage is operatively connected to the gas box 25. The chilling system 10 and DC power supply 3 are housed within the first carriage. This first carriage is operatively connected to the plasma delivery head 13 through a nitrogen supply 9, high voltage supply 12 and a supply of coolant 19, not shown. The plasma delivery head 13 is mounted to the carriage of the railway vehicle 8 such that a plasma output or nozzle 22, not shown, has one end in close communication with the surface of the rail 2 that is to be conditioned.

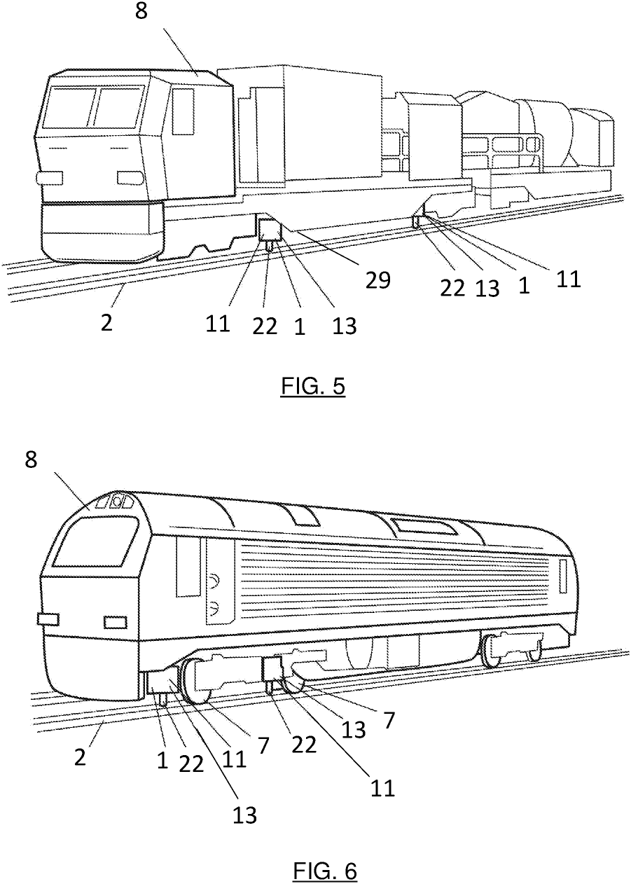

FIG. 5 shows a further embodiment of railway vehicle 8 or track treatment vehicle with a pair of plasma delivery heads 13 mounted at intervals along the undercarriage of the railway vehicle 8. This track treatment vehicle conditions the rails 2 when there are no freight or passenger trains needing to use the line. FIG. 6 shows a surface conditioning device 1 when installed within a typical railway vehicle 8 such as a locomotive, that provides the advantage of conditioning the rails 2 during the usual passage of said railway vehicle 8 along the line. Shown in this modular arrangement are two plasma delivery heads 13 mounted to the undercarriage of the railway vehicle 8, and likely a further pair of plasma delivery heads 13 in a similar location on the other side of the railway vehicle 8. This modular arrangement allows for a number of plasma delivery heads 13 to be conditioning the rails at various locations at any one time, to ensure thorough coverage and conditioning of the surfaces of the railway track rails 2. Each portion of rail 2 is therefore subjected to multiple passes of surface conditioning with just one pass of the railway vehicle 8.

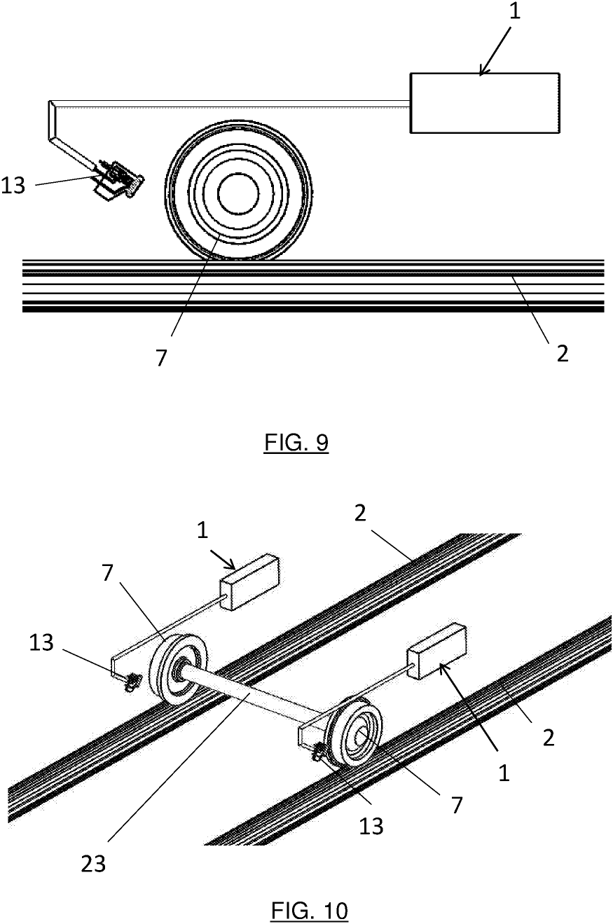

For each of FIGS. 3 to 6, the plasma delivery heads 13 may additionally or alternatively be mounted to condition the surfaces of the wheels 7 of the railway vehicles 8, as shown for example in FIGS. 9 and 10. In these embodiments the plasma delivery heads 13 would be mounted such that the output or nozzle is directed towards, yet at a suitable distance from, the surface of each wheel 7 of the railway vehicle 8 that requires conditioning.

Some of the components that make up the surface conditioning device 1 may be located at a fair distance away from the plasma delivery head 13 within any of these railway vehicles 8. This allows any bulky or heavy components of the surface conditioning system 1 to be located in a more suitable position within the railway vehicle 8. The sensitive elements that make up the surface conditioning device 1 may be provided with a buffer or vibration damping element, not shown, to prevent those elements from being exposed to vibrations and shocks during operation.

A surface monitoring device 29 may be operatively connected to an optimiser 31 as shown, for feeding instructions back to the surface conditioning device 1, to ensure that a required treatment of the surface is optimised. The optimiser 31 may send instructions through a control device, not shown, to activate further surface conditioning processes

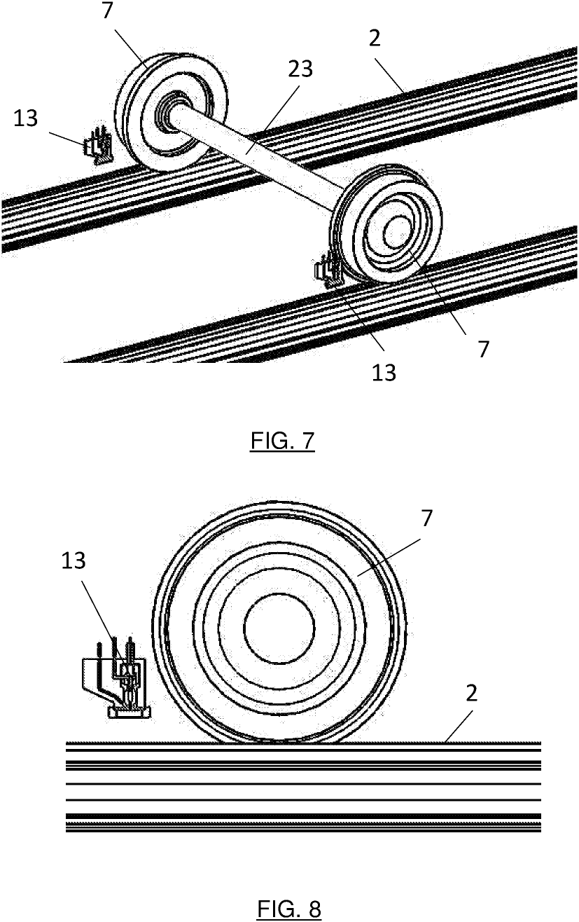

FIGS. 7 and 8 show an isometric view and side view of one possible arrangement of plasma delivery head 13 in relation to wheel 7, when the plasma delivery head 13 is configured to condition the surface of the rail 2. Plasma delivery heads 13 are mounted on each side of the railway vehicle 8, and at a suitable spacing from the wheels 7 and axle 23.

FIGS. 9 and 10 show an isometric view and side view of one possible arrangement of plasma delivery heads 13 when they are configured to surface condition the wheel 7 of the railway vehicle 8, rather than rail 2.

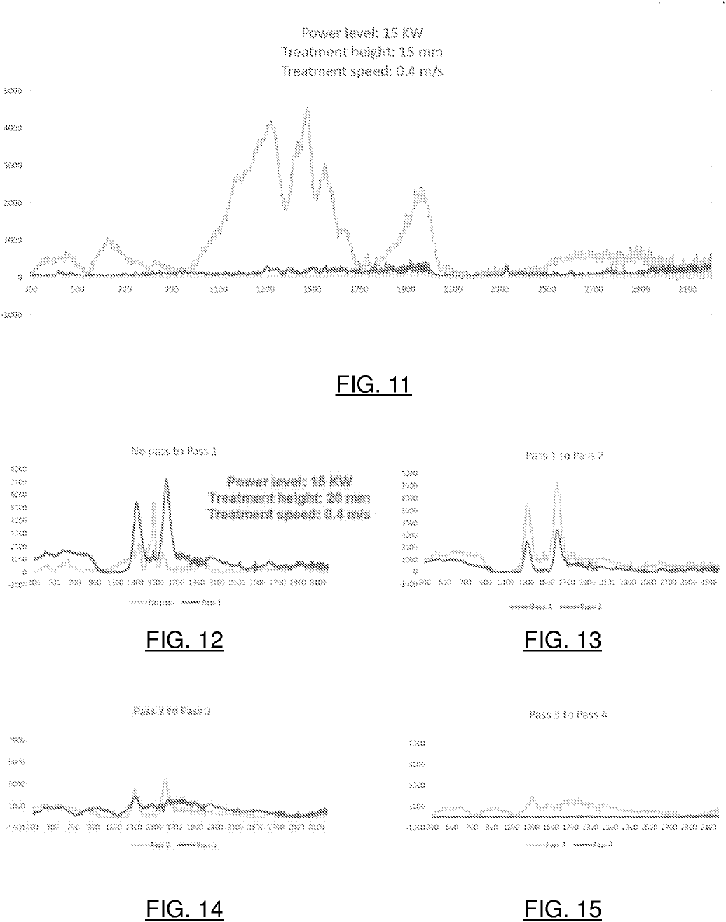

FIGS. 11, 12, 13, 14 and 15 show graphs to illustrate contamination levels on a surface, and the impact of the surface conditioning device 1 when it has passed over a surface. The main peaks on the graphs represent an intensity of contamination and the frequencies represent the compound types. The intensity value is dimensionless as it relates directly to a RAMAN spectrometer algorithm. In FIG. 11 there are high intensities of Cellulose, Cellulose Acetate & Tryosine present. These key compounds are indicators of the presence of leaf layer contamination. The plasma has been tuned to target these compounds and remove them.

This can be seen with the progressive passing of the plasma over the same surface. Each graph shows how the intensity is reduced with each pass of plasma until there is no longer any significant leaf layer remaining, the change in surface condition of the surface following passes of the surface conditioning device 1. FIG. 11 shows the results obtained through RAMAN spectroscopy before passing over the surface conditioning device 1 in grey, and the results of surface condition after conditioning, shown in darker grey. This graph represents an experiment conducted at a treatment height of 15 mm between plasma delivery head 13 and rail 2.

FIGS. 12, 13, 14 and 15 show a series of graphs, with each one in the series showing the results of a further pass of the surface conditioning device 1 over the rail 2, at a treatment height of 20 mm. FIG. 12 shows the change in results from this first condition, shown by the lighter grey line, to the results following a first pass of the surface conditioning device 1. The main peak appears to split, which represents two different components of contamination. FIG. 13 shows the results of a second pass, shown in dark grey, in relation to the results after the first pass, shown in light grey. The peaks have been greatly reduced in size. FIG. 14 shows the condition of the same surface after yet a further pass of the surface conditioning device 1, where results after the second pass are now shown in light grey, and results after this third pass are shown in dark grey. The peaks have evened out some more. FIG. 15 shows the results of a further, or fourth pass, of the surface conditioning device 1. The results of the third pass are shown here in light grey with the results of the fourth pass in dark grey. The peaks have now been virtually eradicated, showing that the surface condition has been optimised after the fourth successive pass.

Where a Raman spectrometer is provided, it may be configured to scan frequencies of particular interest to a driver or other operator on the rail network. Those frequencies may correspond to the components of anticipated contaminants on the rails. For example, frequencies having a wavenumber selected from the group comprising 640, 1430, 1480, 1260, 1213, 1240, 1580, 2000 cm¹. Contaminants of potential interest may include Cellulose, Cellulose Acetate and Tyrosine.

By limiting the Raman spectroscopic analysis to frequencies of particular interest, corresponding to anticipated contaminants of interest, scanning can be carried out much more quickly than if broadband frequencies are scanned. This leads to critical data being available to a driver or other operative much more quickly, thereby improving safety on the railway network.

Results from Raman spectrometry may be displayed to a driver in a driver’s cab or to a person responsible for maintaining the condition of rails. The display may indicate detailed data representing the condition of monitored rails. Additionally or alternatively, it may simply indicate if the condition of a monitored rail is either GOOD or BAD — e.g. indicated by a tick or a cross. This enables a driver or track manager to respond quickly to either change speed or request track conditioning, without having to spend time analysing more detailed data.

Contaminants can be referred to as a third layer, between first and second layers, which are respectively the rail 2 and the wheel 7.

In this specification, the verb “comprise” has its normal dictionary meaning, to denote non-exclusive inclusion. That is, use of the word “comprise” (or any of its derivatives) to include one feature or more, does not exclude the possibility of also including further features. The word “preferable” (or any of its derivatives) indicates one feature or more that is preferred but not essential.

All or any of the features disclosed in this specification (including any accompanying claims, abstract and drawings), and/or all or any of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1-21. (canceled)

22. A surface conditioning device for railway track rails and/or railway vehicle wheels, the surface conditioning device comprising:
a DC power supply;
a supply of gas;
a plasma delivery head connected to receive DC power from said power supply and gas from said gas supply; and
an igniter for igniting said gas in said plasma delivery head;
wherein plasma is generated within said delivery head by ignition of said gas in said delivery head, and plasma with gas is blown from the delivery head onto a railway track rail and/or railway vehicle wheel, thereby conditioning said rail and/or wheel.

23. The surface conditioning device of claim 22, wherein said gas comprises nitrogen.

24. The surface conditioning device of claim 22, wherein said gas comprises a mixture of gases.

25. The surface conditioning device of claim 24, wherein said mixture of gases comprise a mixture of hydrogen and nitrogen or a mixture of nitrogen and oxygen.

26. The surface conditioning device of claim 22, wherein said gas includes argon as an initial gas to initiate ignition and another gas or mixture of gases to replace the argon and generate the plasma.

27. The surface conditioning device of claim 22, wherein the power supply is a dual-voltage inverter power supply.

28. The surface conditioning device of claim 22, further comprising a heat exchange system that is operative to reduce a temperature at or in the vicinity of the plasma delivery head.

29. The surface conditioning device of claim 22, further comprising an anti-freeze system that is operative to circulate an anti-freeze medium at or in the vicinity of the plasma delivery head.

30. The surface conditioning device of claim 22, further comprising a cooling system that is operative to circulate coolant at or in the vicinity of the plasma delivery head.

31. The surface conditioning device of claim 22, wherein the plasma delivery head operates at a temperature in the range 300° C.-1500° C.

32. The surface conditioning device of claim 22, further comprising a Raman spectrometer that is operative to sense the presence or absence of contaminants on a railway track rail and/or railway vehicle wheel, without contact with the rail or wheel.

33. The surface conditioning device of claim 32, wherein the Raman spectrometer is operative to analyse a composition of said contaminants and indicate a level of contamination.

34. The surface conditioning device of claim 32, further comprising an optimizer that is operative to optimize energy requirement for conditioning of the rail or wheel, in response to an output of the Raman spectrometer.

35. The surface conditioning device of claim 32, further comprising a Raman spectrometer that is operative to sense a level of achievement of conditioning of a rail or wheel.

36. The surface conditioning device of claim 22, comprising a plurality of said plasma delivery heads spaced along a direction of travel along a rail, such that said delivery heads successively condition the rail, one after another.

37. The surface conditioning device of claim 22, including an operating interface whereby a user can control operation of the surface conditioning device.

38. A method of conditioning a railway track rail and/or railway vehicle wheel, the method comprising operating the surface conditioning device of claim 1 to condition a rail or wheel.

39. The method of claim 38, wherein the surface conditioning device is operated on a railway vehicle as it travels along a railway track rail.

40. The method of claim 38, wherein the surface conditioning device is operated as the railway vehicle makes multiple passes along the railway track rail.
